(19) United States
(12) Patent Application Publication
(10) Pub. No.: US 2026/0175587 A1
(43) Pub. Date: Jun. 25, 2026

(54) INK STORAGE CONTAINER, INK CARTRIDGE, AND RECORDING APPARATUS

(71) Applicant: CANON KABUSHIKI KAISHA, Tokyo (JP)

(72) Inventors: NARUMI SHINOHARA, Kanagawa (JP); ISAO OTANI, Kanagawa (JP); JUNICHIRO IRI, Kanagawa (JP)

(21) Appl. No.: 19/382,053

(22) Filed: Nov. 6, 2025

(30) Foreign Application Priority Data
Nov. 14, 2024 (JP) 2024-199186

(51) Int. Cl. B41J 2/175

(52) U.S. Cl. CPC B41J 2/17513; B41J 2/17523; B41J 2/17553; B41J 2002/17516

(57) ABSTRACT

An ink storage container includes an ink storage portion configured to be flexible and store ink therein and an ink supply portion configured to supply the ink stored in the ink storage portion to an outside, wherein in the ink storage portion, a length of one edge on one surface (x millimeter (mm)) is longer than a length of one edge on a corresponding surface (y mm), and a relationship of 1.004 ≤ x/y ≤ 1.038 is satisfied.

### BACKGROUND

### Field of the Technology

The present disclosure relates to an ink storage container, an ink cartridge, and a recording apparatus.

### Description of the Related Art

A liquid discharge apparatus of an inkjet printer and the like (hereinafter, simply referred to as "apparatus", "recording apparatus", or the like) is provided with a liquid storage container for supplying a liquid, such as ink (for example, an ink cartridge, an ink pack, or the like). One form of an ink storage container for storing ink of an inkjet printer is an ink bag. As an example of a configuration of an ink storage container, there is an ink bag type structure described in Japanese Patent Laid-Open No. 2021-84249.

In the configuration described in Japanese Patent Laid-Open No. 2021-84249, an ink pack for storing ink includes a bag body for storing ink, leaf spring members, and an ink outlet portion. The bag body includes two upper and lower films and two side films. The upper and lower films are substantially rectangular, and the ink pack has long sides and short sides. A plurality of leaf spring members is disposed at both ends of the ink pack, with the ink outlet portion positioned at the center, that is, at both end portions of the short sides of the bag body. With the above-described configuration, in a state in which the ink pack is filled with ink, the plurality of leaf spring members is maintained in an extended state due to the pressure of the ink, and as the ink flows out and the internal pressure within the bag body decreases, the plurality of leaf spring members gradually curls into a spiral shape. Alternatively, if the bag body itself is configured as a member that elastically deforms to curl due to an ink outflow, a biasing member, such as leaf spring members, can be omitted. Therefore, the configuration in which a curled shape of a bag body facilitates flow of ink toward an ink outlet port to improve the ink use-up efficiency has been proposed.

However, when the curled direction is limited to the short sides, it is difficult to use up the ink left along the long sides. In addition, if the leaf spring members and the bag body with elastic deformability are required to be employed in the configuration, it may impose constraints on the cost and material selection.

Further, conventionally, in order to improve the use-up efficiency of an ink storage container, such as the ink pack, a structure for causing the ink storage container to be tilted may be disposed inside a unit in which the ink storage container is attached. If the structure for tilting the ink storage container is disposed, a space for the structure is required, which may lead to a concern about an increase in the size of an apparatus to which the ink storage container is attached.

### SUMMARY

The present disclosure is directed to providing an ink storage container with improved ink use-up efficiency, an ink cartridge using the ink storage container, and a recording apparatus.

According to some embodiments of the present disclosure, an ink storage container includes an ink storage portion configured to be flexible and store ink therein and having a first surface, and a second surface facing the first surface and having a first edge and a second edge which are shared with the first surface, and an ink supply portion disposed on the first edge of the ink storage portion and configured to supply the ink stored in the ink storage portion to an outside, wherein a length of one edge of the ink storage portion on the first surface is longer than a length of a corresponding edge of the ink storage portion on the second surface, and wherein when the length of the one edge on the first surface is x millimeter (mm) and the length of the corresponding edge on the second surface is y mm, a relationship of 1.004 ≤ x/y ≤ 1.038 is satisfied.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view of an ink storage container in an embodiment.

FIG. 2 is an exploded view of a configuration of the ink storage container according to the embodiment.

FIG. 3 is a perspective view of an ink storage container according to a first embodiment.

FIG. 4A is a diagram illustrating an ink storage container according to the first embodiment, and FIG. 4B is a cross-sectional view of the ink storage container.

FIG. 5A is a diagram illustrating the ink storage container according to the first embodiment, and FIG. 5B is a cross-sectional view of the ink storage container.

FIG. 6 is a perspective view of an ink storage container according to a second embodiment.

FIG. 7 is a perspective view of an ink storage container according to a third embodiment.

FIG. 8 is an exploded view of a configuration of the ink storage container according to the third embodiment.

### DESCRIPTION OF THE EMBODIMENTS

Hereinafter, various exemplary embodiments, features, and aspects of an ink storage container and a recording apparatus according to the present disclosure will be specifically described with reference to the drawings. Each of the following embodiments is a desirable example for implementing the present disclosure, and the present disclosure is not limited to these configurations. Features described in the embodiments may be combined in part. In the following description, the same reference numerals are given to the same components in the drawings, and the redundant description may be omitted.

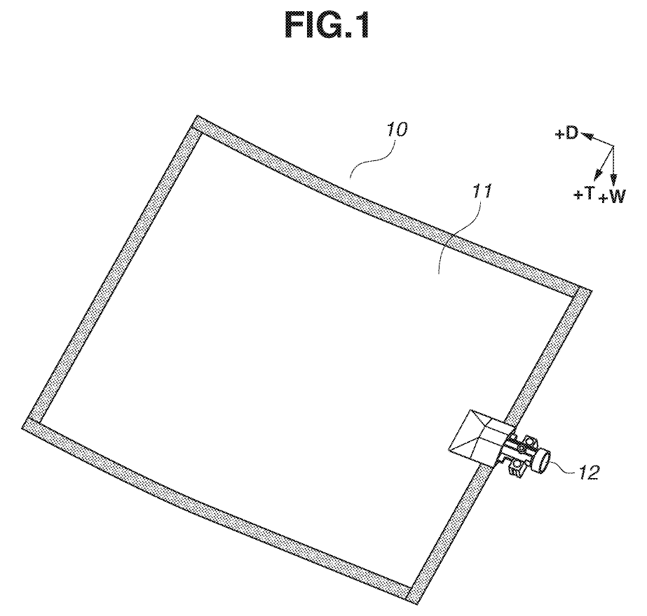

An ink storage container 10 described below is used as, for example, an ink tank that is mounted on an inkjet recording apparatus, such as an inkjet printer. Directions are defined for the purpose of describing the present disclosure. FIG. 1 is a perspective view of the ink storage container 10. A direction of gravity when the ink storage container 10 is placed in a stationary state is defined as a +W direction. A surface of the ink storage container 10 facing downward when the ink storage container 10 is placed in the stationary state is the same as a surface of the ink storage container 10 facing downward when the ink storage container 10 is mounted on the inkjet recording apparatus. A horizontal direction when the ink storage container 10 is placed in the stationary state is defined as a +T direction.

A direction opposite to the +W direction is defined as a -W direction and a direction opposite to the +T direction is defined as a -T direction. Further, a +D direction is defined as a direction orthogonal to the +W direction and the +T direction, extending from one end of the ink storage container 10 where an ink supply port 12 is disposed, toward the other end. Thus, when the ink storage container 10 is mounted on the inkjet recording apparatus, a direction in which the ink storage container 10 is connected to the inkjet recording apparatus is defined as a -D direction. Alternatively, a direction in which a storage unit for accommodating the ink storage container 10 is pushed into the inkjet recording apparatus is defined as the -D direction, and a direction in which the storage unit is pulled out from inside the inkjet recording apparatus to a position where the ink storage container 10 can be attached and detached is defined as the +D direction.

A liquid (ink) for use in image recording includes any liquid that can be used for forming an image or processing a recording medium by being applied to the recording medium. The term "ink" in the present specification is a concept encompassing any liquid that can be used for recording. Specifically, the ink may be a colored ink containing a colorant, such as a pigment or a dye, or a colorless and transparent ink, such as a reaction liquid or an optimizer.

The recording medium to which the ink is applied is not particularly limited, and a transparent or colored recording medium may be used. The recording medium may also be a low-absorbency medium (non-absorbent medium), such as a resin film, which has low liquid medium absorbency. For example, a known material and form, such as paper, cloth, an optical disk label surface, a plastic sheet, an overhead projector (OHP) sheet, an envelope, or the like, may be used as the recording medium. The recording medium may be cut sheets (cut paper) produced by cutting roll paper into predetermined standard sizes, such as A3 size or A4 size, or may be a form of roll paper which is used in a so-called roll-to-roll format.

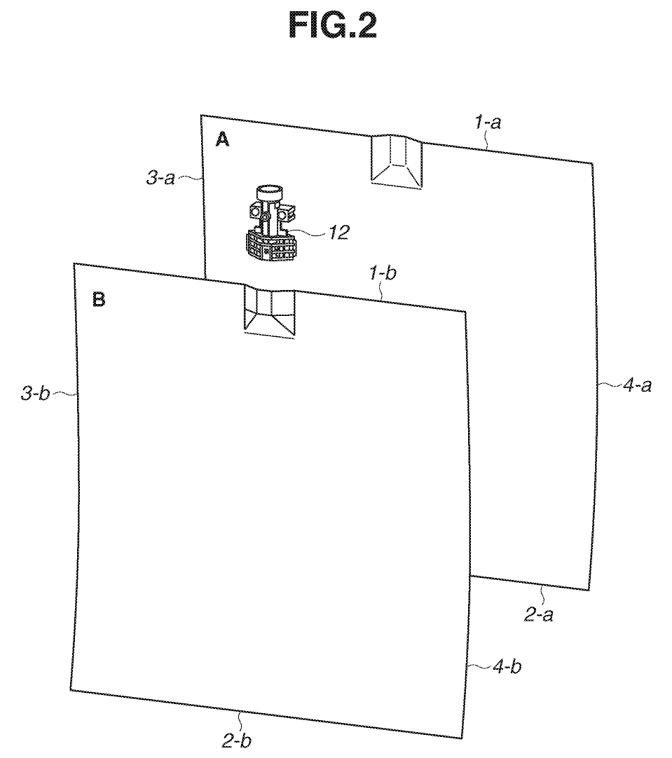

FIG. 2 is an exploded view illustrating the ink storage container 10. The ink storage container 10 includes an ink storage bag 11 in which ink is stored, and the ink storage bag 11 has a shape formed into a bag by, for example, heat-sealing a deformable flexible film. The ink storage bag 11 has a first surface and a second surface, and is configured with a first edge, a second edge, a third edge, and a fourth edge which are shared by the first and second surfaces. The first surface (A) has a first-a edge (1-a), a second-a edge (2-a), a third-a edge (3-a), and a fourth-a edge (4-a), and the second surface (B) has a first-b edge (1-b), a second-b edge (2-b), a third-b edge (3-b), and a fourth-b edge (4-b). To improve the ink use-up efficiency, it is more desirable that a layer structure of the ink storage bag 11 be configured to include a material having high deformability and high flexibility. For example, a layer structure including a nylon layer for enhancing impact resistance, an aluminum layer for preventing ink evaporation, and a polyethylene film which provides high flexibility may be employed. The first surface and the second surface do not necessarily have the same layer structure and layer thickness, and in the case of an ink storage bag having different layer thicknesses, it is desirable that the second surface have a smaller layer thickness than the first surface. The thickness of the film is desirably greater than or equal to 100 micrometers (μm) and less than or equal to 220 μm. Further, a tensile modulus (stress-strain (S-S)) of the film is desirably greater than or equal to 30 Newton per square millimeter (N/mm²) and less than or equal to 140 N/mm². The ink storage bag 11 has the ink supply port 12 bonded to the first edge of the first surface by, for example, heat-sealing. In the case of heat-sealing, it is desirable that a material of the ink supply port 12 be the same as the material of the inner layer of the ink storage bag 11. From the viewpoint of the ink storage volume, it is desirable that the heat-sealed portion of the ink storage bag 11 be heat-sealed with a narrow width of about 4 millimeters (mm). While the ink storage container 10 in the present embodiment is a four-side sealed bag, the present embodiment is also effective for other shapes, such as a gusset bag or a fin-seal bag.

The present disclosure is not limited to the above-described embodiment. Various changes and modifications can be made without departing from the spirit and scope of the disclosure. Based on the above-described embodiment, the following embodiments of the present disclosure are described.

### First Embodiment

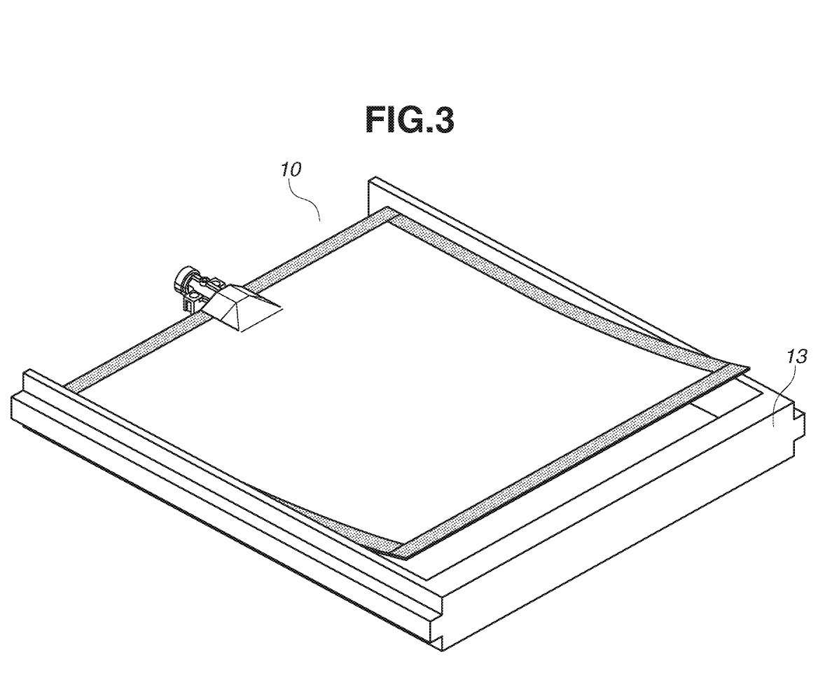

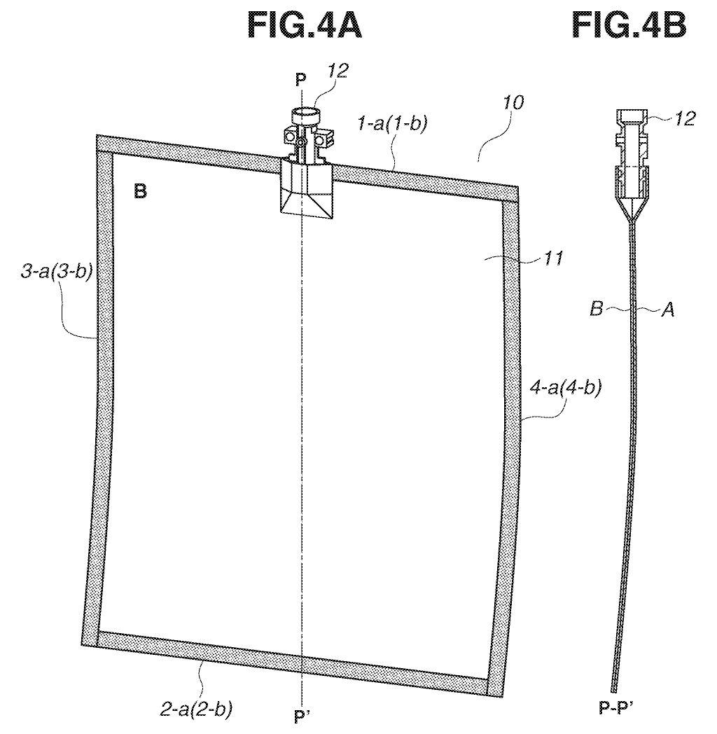

An ink storage container 10 in the first embodiment is installed in an ink storage container installation unit 13 in the inkjet recording apparatus as illustrated in FIG. 3 and used. FIG. 4A is a diagram illustrating the ink storage container 10 according to the present embodiment, and FIG. 4B is a cross section diagram of the ink storage container 10 taken along a line P-P' in FIG. 4A.

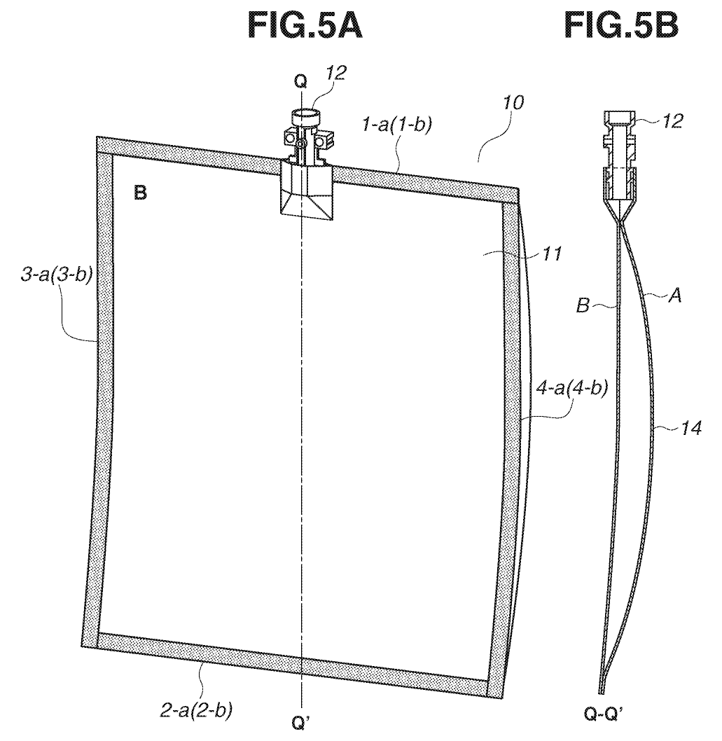

As for a configuration of an ink storage bag 11, lengths of a first-a edge, a first-b edge, a second-a edge, and a second-b edge are set to 140 mm, lengths of a third-a edge and a fourth-a edge of a first surface are set to 140 mm, and lengths of a third-b edge and a fourth-b edge of a second surface are set to 135 mm. Since the lengths of the third-a edge and the fourth-a edge of the first surface are longer than the lengths of the third-b edge and the fourth-b edge of the second surface, the second edge curves upward. Due to the difference in the lengths of the edges, a slack 14 is generated in part of the ink storage bag 11 as illustrated in a cross section diagram illustrated in FIG. 5B taken along a line Q-Q' in FIG. 5A. With generation of the slack 14, ink tends to accumulate in the slack portion, which may deteriorate the ink use-up efficiency. Therefore, it is desirable to manufacture the ink storage bag 11 in such a manner that the portion where the slack 14 is generated is formed in a portion toward the -D direction, which corresponds to the direction of the ink supply port 12, relative to the midpoint of the third and fourth edges. Further, when upward curving occurs, upward curving in the -W direction with a curving angle of greater than or equal to 5° is desirable to improve the ink use-up efficiency, and thus, a ratio between a length x of the third-a edge and the fourth-a edge and a length y of the third-b edge and the fourth-b edge is desirably greater than or equal to x/y = 1.004. On the other hand, from the viewpoint of generation of the slack 14 due to the difference in the lengths of the edges and ease of manufacturing, less than or equal to x/y = 1.038 is desirable. In view of the above, when the length of one edge of the first surface is x mm and the length of the corresponding edge of the second surface is y mm, it is desirable that the relationship satisfy 1.004 ≤ x/y ≤ 1.038.

In the present embodiment, the third-a edge, the third-b edge, the fourth-a edge, and the fourth-b edge are set to be the same length, and the first-a edge and the second-a edge of the first surface are set to be longer than the first-b edge and the second-b edge of the second surface. As a result, the third edge and the fourth edge curve upward from both ends of the ink storage bag 11 with the ink supply port 12 positioned at the center. This configuration is also effective for the ink use-up efficiency. Further, it is desirable that the slack 14 due to the difference in the lengths of the edges be generated at a portion closer to the ink supply port 12 disposed on the first edge.

### Second Embodiment

A second embodiment is described below. As for the forming process and structure that are similar to those of the above-described embodiment, the redundant description using drawings will be omitted. Further, as for specific dimensions, positional relationships, and the like, the redundant descriptions will also be omitted when they are similar to the first embodiment.

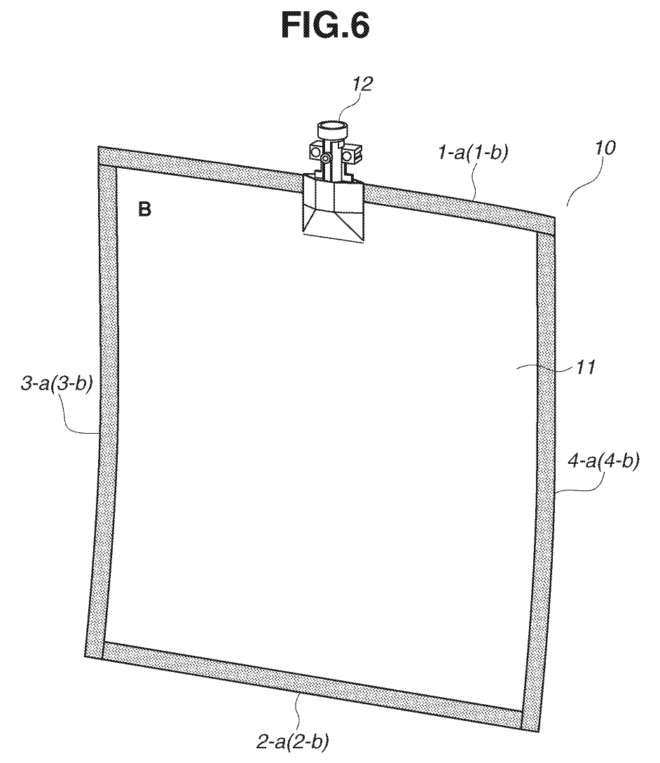

FIG. 6 is a perspective view of an ink storage container 10 in the present embodiment. As for a configuration of an ink storage bag 11, lengths of a first-a edge and a first-b edge are set to 140 mm, lengths of a second-a edge and a second-b edge are set to 135 mm, lengths of a third-a edge and a fourth-a edge of a first surface are set to 140 mm, and lengths of a third-b edge and a fourth-b edge of a second surface are set to 135 mm. Since the lengths of the first-a edge and the second-a edge and the lengths of the third-a edge and the fourth-a edge of the first surface are longer than the lengths of the first-b edge and the second-b edge and the lengths of the third-b edge and the fourth-b edge of the second surface, respectively, the second edge, the third edge, and the fourth edge curve upward.

### Third Embodiment

A third embodiment is described below. As for the forming process and structure that are similar to those of the above-described embodiments, the redundant description using drawings will be omitted. Further, as for specific dimensions, positional relationships, and the like, the redundant descriptions will also be omitted when they are similar to the first and second embodiments.

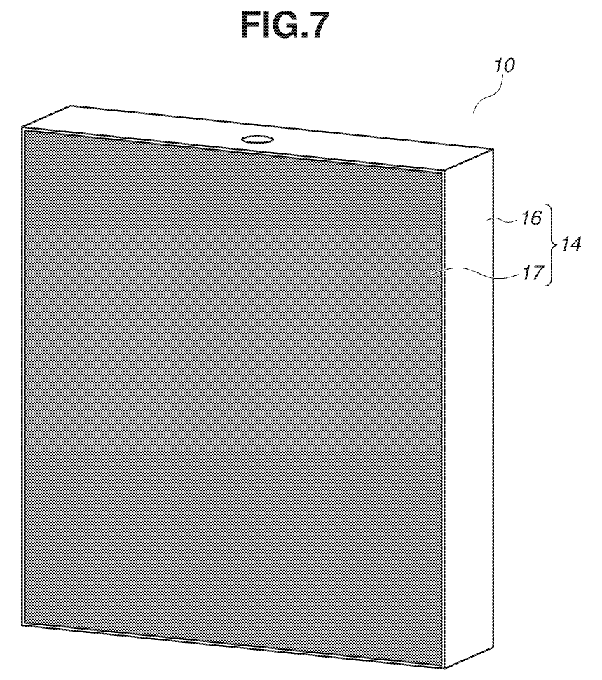

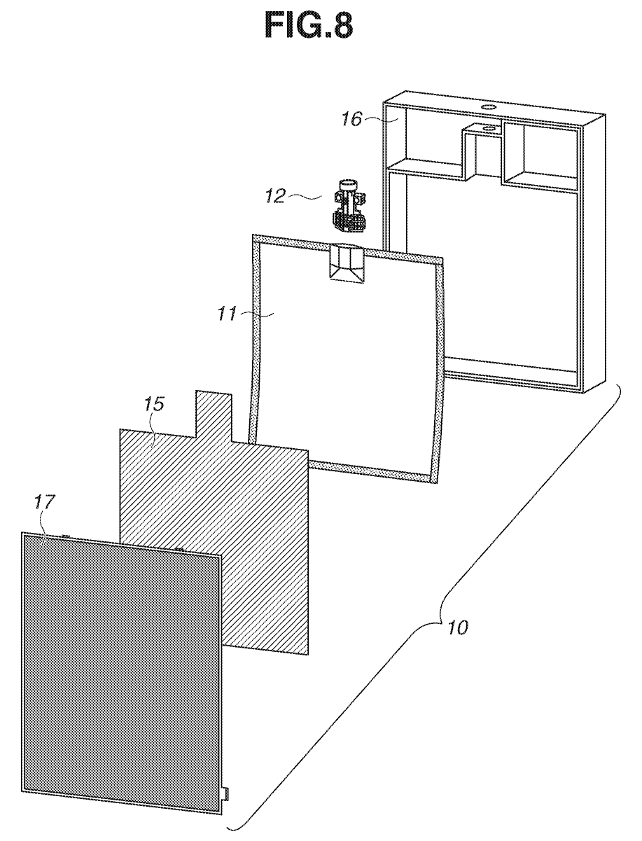

FIG. 7 is a perspective view of an ink storage container (ink cartridge) 10 in the third embodiment, and FIG. 8 is an exploded view of the ink storage container 10 in the third embodiment. The present embodiment describes, so to speak, an ink cartridge that has a housing capable of accommodating an ink storage container therein.

The ink storage container (ink cartridge) 10 includes a housing 18 in which an ink storage bag 11 storing ink is accommodated. One surface of the housing 18 facing a first surface of the ink storage bag 11 is formed of a flexible film 15 (sealing sheet member). The housing 18 is made of, for example, a resin material, and includes a case 16 that is box-shaped and has an opening on one side, and a cover 17 serving as a lid of the case 16. The ink supply port 12 is fixed to the case 16 by, for example, snap-fitting or press-fitting.

The first to third embodiments described above can provide an effect that, when the ink is used up, as the ink is discharged from the ink storage bag, end portions of the ink storage bag curve upward, and residual ink at the end portions is guided toward the ink supply port, which improves the ink use-up efficiency. In addition, since a configuration for tilting an ink storage unit is not involved, an effect of eliminating the need for space for a tilting structure can be expected.

According to the present disclosure, it is possible to provide an ink storage container with improved ink use-up efficiency, an ink cartridge using the ink storage container, and a recording apparatus.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of priority from Japanese Patent Application No. 2024-199186, filed November 14, 2024, which is hereby incorporated by reference herein in its entirety.

What is claimed is:

1. An ink storage container comprising:
an ink storage portion configured to be flexible and store ink therein and having
(1) a first surface, and
(2) a second surface facing the first surface and having a first edge and a second edge which are shared with the first surface; and
an ink supply portion disposed on the first edge of the ink storage portion and configured to supply the ink stored in the ink storage portion to an outside,
wherein a length of one edge of the ink storage portion on the first surface is longer than a length of a corresponding edge of the ink storage portion on the second surface, and
wherein when the length of the one edge on the first surface is x millimeter (mm) and the length of the corresponding edge on the second surface is y mm, a relationship of 1.004 ≤ x/y ≤ 1.038 is satisfied.

2. The ink storage container according to claim 1, wherein a tensile modulus of a layer included in the ink storage container is greater than or equal to 30 Newton per square millimeter (N/mm²) and less than or equal to 140 N/mm².

3. An ink cartridge comprising a housing configured to accommodate an ink storage container therein,
wherein the ink storage container including
an ink storage portion configured to be flexible and store ink therein and having
(1) a first surface, and
(2) a second surface facing the first surface and having a first edge and a second edge which are shared with the first surface, and
an ink supply portion disposed on the first edge of the ink storage portion and configured to supply the ink stored in the ink storage portion to an outside,
wherein a length of one edge of the ink storage portion on the first surface is longer than a length of a corresponding edge of the ink storage portion on the second surface,
wherein when the length of the one edge on the first surface is x millimeter (mm) and the length of the corresponding edge on the second surface is y mm, a relationship of 1.004 ≤ x/y ≤ 1.038 is satisfied, and
wherein a surface of the housing facing the first surface is a flexible film.

4. A recording apparatus comprising:
an apparatus main body; and
an ink storage container configured to be attachable to and detachable from the apparatus main body;
wherein the ink storage container including
an ink storage portion configured to be flexible and store ink therein and having
(1) a first surface, and
(2) a second surface facing the first surface and having a first edge and a second edge which are shared with the first surface, and
an ink supply portion disposed on the first edge of the ink storage portion and configured to supply the ink stored in the ink storage portion to an outside,
wherein a length of one edge of the ink storage portion on the first surface is longer than a length of a corresponding edge of the ink storage portion on the second surface, and
wherein when the length of the one edge of the first surface is x millimeter (mm) and the length of the corresponding edge of the second surface is y mm, a relationship of 1.004 ≤ x/y ≤ 1.038 is satisfied.

5. The recording apparatus according to claim 4, wherein a tensile modulus of a layer included in the ink storage container is greater than or equal to 30 Newton per square millimeter (N/mm²) and less than or equal to 140 N/mm².

6. The recording apparatus according to claim 4, further comprising a housing configured to accommodate the ink storage container therein,
wherein a surface of the housing facing the first surface is a flexible film.
